(19) United States
(12) Patent Application Publication
(10) Pub. No.: US 2024/0094960 A1
(43) Pub. Date: Mar. 21, 2024

(54) SYSTEMS AND METHODS FOR REAL TIME ACCESS TO EXTERNAL RESOURCE

(71) Applicant: The Toronto-Dominion Bank, Toronto (CA)

(72) Inventors: Milos DUNJIC, Oakville (CA); David Samuel TAX, Toronto (CA); Kushank RASTOGI, Toronto (CA); Thomas Osman KELLY, Wenonah, NJ (US); Pranay Chander GUPTA, Toronto (CA); Hitesh BAJAJ, Duluth, GA (US); Asad JOHEB, Toronto (CA)

(73) Assignee: The Toronto-Dominion Bank, Toronto, ON (CA)

(21) Appl. No.: 17/947,226

(22) Filed: Sep. 19, 2022

(51) Int. Cl. G06F 3/06

(52) U.S. Cl. CPC G06F 3/0655; G06F 3/0604; G06F 3/0673

(57) ABSTRACT

A computer-implemented method is disclosed. The method includes: receiving an initiation request for a data transfer associated with a terminal; determining that a resource external to the first logical storage area should be accessed to complete the data transfer; in response to determining that the resource external to the first logical storage area should be accessed to complete the data transfer, triggering a query message to an electronic device accessible to an entity associated with the first logical storage area, the query message prompting for an instruction to access the resource external to the first logical storage area to complete the transfer; receiving, from the electronic device, an instruction to access the resource external to the first logical storage area to complete the transfer; and in response to receiving the instruction, effecting the transfer using the resource external to the first logical storage area.

### TECHNICAL FIELD

The present application relates to computer handling of transfer initiation requests associated with a logical storage area and, more particularly, to systems and methods for facilitating real-time access to an external resource.

### BACKGROUND

In a computer network, resources may be shared or transferred between nodes of the network. For example, computing resources, such as processing units, memory, etc., may be transferred between nodes in order to attain a desired distribution of resources for a computer network. As another example, electronic transfers of data between data records may effect changes to the quantum of resources associated with the data records.

Requests for transfers of resources may be directed to a computing system that processes and handles such requests. Instructions may be received by the computing system to remove or transfer a resource from a logical storage area such as a user account. In some instances, removal of a resource from a logical storage area may cause problems in the future such as, for example, a future overload condition, which may be caused due to a shortfall in resources. Further, even in situations in which a future overload condition may not be caused, it may be that transfer of the resources directly from the logical storage area may be undesirable for other reasons. For example, it may be that the logical storage area should, preferably, reflect at least a threshold amount of resources in case unexpected resource calls are received.

In some cases, resources may be available in an external logical storage area, such as a second account, on an external system. By way of example, the external logical storage area may be associated with an earned wage access service. However, even where resources are externally available, users may not access such external resources since they may not know that they are available or they may find it difficult to access such external resources. Further, users may find it difficult to identify situations in which it is desirable to access external resources.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method of processing a transfer;

FIG. 4 shows, in flowchart form, an example method of determining whether an external resource should be used to complete a transfer;

FIG. 5 shows an example query message provided on a user interface of an electronic device;

FIG. 6 shows, in flowchart form, a further example method of determining whether an external resource should be used to complete a transfer; and

FIG. 7 shows a further example query message provided on a user interface of an electronic device.

Like reference numerals are used in the drawings to denote like elements and features.

### DETAILED DESCRIPTION OF VARIOUS EMBODIMENTS

In an aspect, the present disclosure describes a computing system for handling a transfer event. The computing system includes a processor and a communications module coupled to the processor. The computing system includes a memory coupled to the processor. The memory stores processor-executable instructions that, when executed by the processor, cause the processor to: receive an initiation request for a data transfer associated with a point-of-sale terminal, the initiation request associated with a first logical storage area; determine, based on account data for the first logical storage area, that a resource external to the first logical storage area should be accessed to complete the data transfer; in response to determining that the resource external to the first logical storage area should be accessed to complete the data transfer, trigger a query message to an electronic device accessible to an entity associated with the first logical storage area, the query message prompting for an instruction to access the resource external to the first logical storage area to complete the transfer; receive, from the electronic device, an instruction to access the resource external to the first logical storage area to complete the transfer; and in response to receiving the instruction to access the resource external to the first logical storage area to complete the transfer, effect the transfer using the resource external to the first logical storage area.

In some implementations, the electronic device accessible to the entity includes one or both of the point-of-sale terminal and a device associated with the first logical storage area.

In some implementations, effecting the transfer using the resource external to the first logical storage area includes sending a transfer request to an external resource system to re-allocate a first quantity of resources from an external logical storage area to another logical storage area.

In some implementations, the another logical storage area is the first logical storage area.

In some implementations, the another logical storage area is a storage area associated with a merchant that is associated with the point-of-sale terminal.

In some implementations, determining, based on account data for the first logical storage area, that a resource external to the first logical storage area should be accessed to complete the data transfer includes determining that an accumulated resource amount associated with a resource transfer scheduled to occur at a future time is available for immediate access.

In some implementations, determining, based on account data for the first logical storage area, that a resource external to the first logical storage area should be accessed to complete the data transfer further includes determining that the accumulated resource amount is of an amount sufficient to complete the transfer.

In some implementations, determining, based on account data for the first logical storage area, that a resource external to the first logical storage area should be accessed to complete the data transfer further includes determining that at least a threshold amount of resources will remain available for transfer at the scheduled time if the transfer were to be completed with resources in the accumulated resource amount.

In some implementations, the instructions configure the processor to determine the threshold based on the account data.

In some implementations, the query message indicates that the resource external to the first logical storage area should be used to complete the transfer.

In some implementations, the query message indicates a plurality of transfer options including an option to use the external resource to complete the transfer and an option to use resources in the first logical storage area to complete the transfer.

In some implementations, an order of the transfer options reflects suggested options such that the option to use the external resource to complete the transfer is displayed more prominently in response to determining that the resource external to the first logical storage area should be accessed to complete the data transfer.

In some implementations, determining, based on account data for the first logical storage area, that a resource external to the first logical storage area should be accessed to complete the data transfer includes determining that a borrowed resource is available to complete the transfer.

In some implementations, determining, based on account data for the first logical storage area, that a resource external to the first logical storage area should be accessed to complete the data transfer includes determining that an overload condition will occur at a future time without use of the resource external to the first logical storage area and wherein the overload condition to determined to occur based on predicted future transfers identified based on past transfers.

In another aspect, a method is described. The method may include: receiving an initiation request for a data transfer associated with a point-of-sale terminal, the initiation request associated with a first logical storage area; determining, based on account data for the first logical storage area, that a resource external to the first logical storage area should be accessed to complete the data transfer; in response to determining that the resource external to the first logical storage area should be accessed to complete the data transfer, triggering a query message to an electronic device accessible to an entity associated with the first logical storage area, the query message prompting for an instruction to access the resource external to the first logical storage area to complete the transfer; receiving, from the electronic device, an instruction to access the resource external to the first logical storage area to complete the transfer; and in response to receiving the instruction to access the resource external to the first logical storage area to complete the transfer, effecting the transfer using the resource external to the first logical storage area.

In yet another aspect, a computer readable storage medium is described. The computer readable storage medium may be a non-transitory computer readable storage medium. The computer readable storage medium may include instructions which, when executed, configure a computing system to perform a method described herein.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application makes reference to a “transfer message” or a “transfer” or a “transfer event” or a “transfer instruction”. These terms refer a computer-readable message configured for transmission over one or more computer networks between computing systems or devices. The transfer message or instruction may be a structured message having a defined schema or set of predefined fields to contain data in some cases. The transfer message or instruction may be used to instruct a recipient system to transfer resources relating to a user account or data record. In some cases, the transfer instruction may relate to a payment or other transaction involving the user account or data record by which the quantity of resources associated with the user account or data record is to be decreased by the transfer quantity. The resources may be currency, physical assets, credits, tokenized items like non-fungible tokens, computing resources such as memory allocated or processor time, access rights, or any other resource that may be owned or credited to an account associated with an account holder. In many of the examples below, monetary resources may be referenced to illustrate concepts, but the present application is not necessarily solely applicable to financial or monetary instruments or resources.

In the present application, the term account or user account may be used interchangeably with “logical storage area” or “record” or “record in a database.”

In the present application, the terms “transferor” and “transferee” may be used interchangeably with “sender” and “recipient”, respectively, in the context of describing transfers of resources. In some cases, the terms “payor” or “payee” may be used in the example of monetary resources.

In some instances, a transfer instruction may, when applied to a user account, result in an overload condition at a future point in time or it may result in a depletion of resources below a safety threshold. The safety threshold is a threshold that may be defined to allow for unexpected or unpredictable drains on resources.

User accounts may receive regularly scheduled replenishments; for instance, a mobile connectivity account may have a monthly data allocation, a computing resources account may have a monthly server time allocation, or a bank account may have a regular income deposit (e.g. payroll payment). In some cases, external systems may exist to enable a user or administrator to receive an early allocation of resources before the scheduled replenishment, i.e. an “advance” of resources. For example, in the case of payroll, some services exist that, in concert with a payroll system, make wages available earlier than the regular payroll processing schedule. That is, an employee may request early access to earned wages. One example of such a system is DailyPay™ of New York, US. There may be a cost or surcharge for early access to resources in some cases. In this way, replenishment of resources may be performed as a push operation (e.g., through a regularly-scheduled top-up) or as a pull operation (e.g., where resources are topped-up as needed).

In some instances, external resources, such as resources at an external system which may provide an early allocation of resources, may be used as an alternative to internal resources (i.e., resources already stored in a user account). However, determining whether such external resources are available and whether, even if available, such external resources should be used, may be difficult for a user. To do so, a customer may need to repeatedly check the availability of such external resources with an external system. This may involve more active user logins and monitoring of account status and available resource status on both the computing system and the external resource system to proactively manage potential shortfalls and make anticipatory requests for early access. This is potentially wasteful of both user time and energy and of the processing power, bandwidth usage, and memory footprint of the computing system, the user's client devices, and/or the external resource system.

Further, even when external resources are available, it may not be advantageous to access such resources in every instance. While a user may wish to maintain some control over whether external resources will be accessed, there may be computing efficiencies and other benefits for a user if a system were to notify the user of a preferred option of whether or not to use external resources based on context.

Accordingly, the present application provides for methods and systems integrated into transfer processing that determine whether an external resource is available and allow a user to select, prior to completion of transfer processing, whether the external resource should be used for a particular transfer. In this way, a user may determine on-the-fly (i.e., at the time of transfer processing) whether or not external resources should be accessed and/or may allow the user to confirm whether such external resources are to be used on-the-fly.

In at least some implementations, the user is only presented with the option to use the external resources if such external resources are available. When such resources are not available, the selectable option to use the external resources is suppressed.

Further, in at least some implementations, the system determines whether external resources are preferred and it may notify the user that it is preferred to use external resources. This may remove the likelihood of inadvertent or avoidable overload conditions and prevent the waste of user and system time inherent in having the user constantly monitor the account level in order to take anticipatory action to avoid such overload conditions. The real-time monitoring of external resources and the providing of a selectable option to use external resources during transaction processing only when such resources are, in fact, available and, in at least some implementations when it is determined that such external resources should be used, produces an improved transfer processing system that allows greater resource control in a computing-efficient manner.

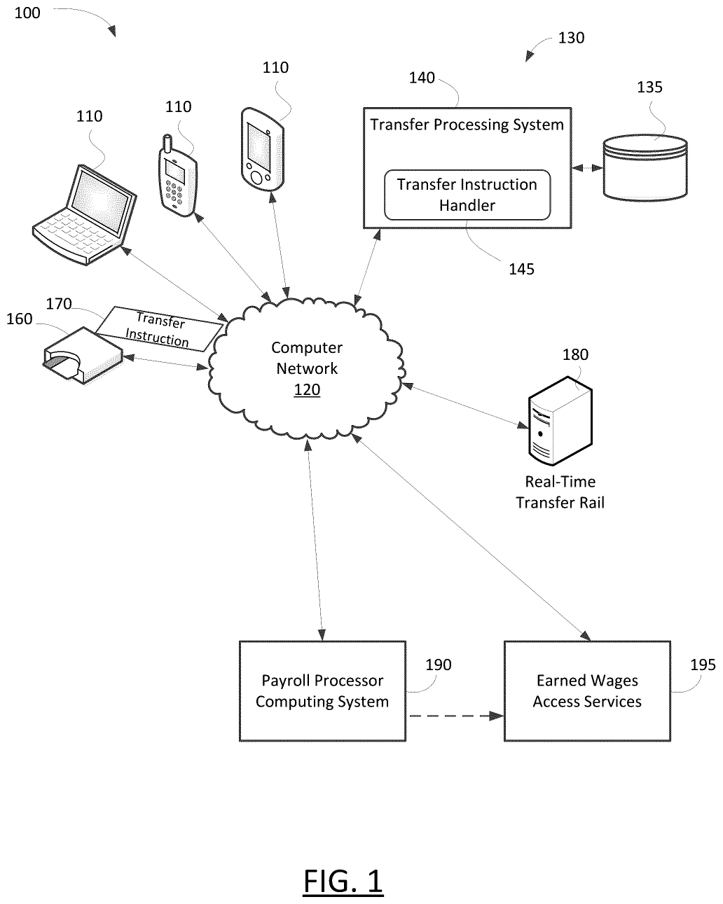

FIG. 1 is a schematic diagram illustrating an operating environment of an example embodiment. In particular, FIG. 1 illustrates exemplary components of a system 100 for processing transfers of resources between computing systems. As a specific example, the system 100 may be implemented to facilitate processing and handling of requests to transfer resources (e.g., transfer instructions) between logical storage areas such as resource accounts (or data records associated therewith). More generally, the components of system 100 enable processing of resource transfer requests that are directed to a resource account management system.

As illustrated, a computing system 130 and one or more client devices 110 communicate via a computer network 120. The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

The client devices 110 are network-capable computing devices. For example, the client device 110 may include various computing devices, including desktop computers, laptop computers, mobile devices, smartphones, tablets, etc. One or more client devices 110 may be configured to access the computing system 130 or another resource storage or accounting system using a dedicated application and/or a web browser. One or more of the client devices 110 may be associated with an account holder that has one or more logical resource storage areas, such as accounts, defined within the computing system 130. The accounts may be associated with account holder log in and authentication data for authenticating requests for access or commands or operations in relation to the accounts.

The computing system 130 may track, manage, and maintain resources for a plurality of users in association with respective defined logical storage areas (e.g., accounts). The resources may, for example, include computing resources, such as memory or processor cycles, bandwidth, data or memory usage, etc. By way of further example, the resources may include stored value, such as fiat currency, which may be represented in one or more databases. For example, as shown in FIG. 1, the computing system 130 may include a database 135, which may be provided in secure storage. In some embodiments, the secure storage may include one or more data centers. The data centers may, for example, store data with bank-grade security.

The computing system 130 may include a transfer processing system 140 configured to receive and authenticate transfer instructions and to execute operations to give effect to transfer instructions. The transfer processing system 140 may include a transfer instruction handler 145 implemented to automatically process resource transfer instructions that are received by the transfer processing system 140. Specifically, the transfer instruction handler 145 may be configured to process requests to transfer resources that are associated with one or more resource accounts managed by the computing system 130. In the normal course, the transfer instruction handler 145 may receive, for example, a payment instruction directing payment of a transaction from funds in a user account on the computing system 130. The transfer instruction handler 145 may verify or authenticate the instruction as a legitimate instruction, identify the associated user account, confirm sufficient funds exist associated with the user account, debit the user account by the transfer quantity, and carry out operations to transfer the transfer quantity to the payee of the payment instruction. Various inter-bank or third-party communications may be involved in processing such a payment, which may take the form of a direct withdrawal, debit transaction, email money transfer, or any other form of such a transaction. If insufficient funds are present in association with the user account, then the transfer instruction handler 145 may be configured to refuse or decline the transfer instructions or, if the user account is configured to permit a negative balance or overdraft state, then it may carry out the transfer instruction and record the negative balance of resources in association with the user account.

The transfer instruction handler 145 may be implemented by one or more modules or applications containing processor-executable instructions stored in memory in the transfer processing system 140 and configured to cause one or more processors to carry out operations described herein, once executed by the one or more processors. The present application is not intended to be limited to any specific computing system architecture, operating system, or programming language.

The computing system 130 may, for example, be one or more financial institution servers and the entity associated with one of the client devices 110 may be a customer of a financial institution operating the one or more financial institution servers.

As shown in FIG. 1, the system 100 may include a real-time transfer rail 180. In at least some embodiments, the real-time transfer rail 180 may be a payment rail. For example, the real-time transfer rail 180 may be hosted by a real-time payment system that includes a real-time payment server. The real-time payment system may be associated with a third-party and be configured to receive a resource (e.g., data) transfer request. The resource transfer request may include a request to transfer resources from a first data record to a second data record. The first data record may include a data record associated with a user account on the computing system 130 and the second data record may include a data record associated with a recipient stored on another computing system or on the computing system 130. For example, the first data record may be associated with a payor account in a first financial institution database and the second data record may be associated with a payee account in a second financial institution database.

The request to transfer resources may be a request to transfer data such as, for example, units of value. The units of value may include a quantity of currency. The transferee or transferor may initiate the resource transfer request using, for example, a computing device. In some cases, the request may originate via a point-of-sale terminal 160, which may also be referred to as a point-of-sale device. The point-of-sale terminal 160 may be a hardware system for processing card payments at a retail location. The point-of-sale terminal 160 may include a physical token reader. The point-of-sale terminal may include a communications module. The point-of-sale terminal may include a display module. The point-of-sale terminal may include an input module. The point-of-sale terminal may include a processor coupled with the communications module, the input module, the display module and the physical token reader. The POS terminal 160 may be located at a location that is associated with a merchant. By way of example, the merchant may be a store, restaurant, gym, etc.

Responsive to receiving a resource transfer request, a real-time payment system may complete the resource transfer request using the real-time transfer rail 180. Specifically, a real-time payment server may be configured to receive the resource transfer request and to facilitate the resource transfer from the first data record associated with the transferor to the second data record associated with the transferee in real-time. In some embodiments, the resource transfer may be irrevocable; that is, the transferor may not be able to retrieve the transferred resources after the transfer. In some cases, the real-time payment rail 180 communicates with the computing system hosting the first data record to confirm that sufficient resources are stored in association with the first data record before completing processing of the real-time resource transfer request.

The real-time transfer rail 180 may be configured to complete resource transfer requests in real-time or substantially in real-time. In at least some embodiments, real-time is defined as being within seconds. Certain factors, such as network traffic, may limit the immediacy of real-time transfers and/or processing of transfer requests.

In some implementations, the real-time transfer rail 180 is a third-party transfer rail that operates between respective financial institutions. That is, a transfer instruction may be sent from one computing system or a point-of-sale terminal to the real-time transfer rail 180 where it is authenticated and processed in real-time to generate a payment confirmation in response. The real-time processing may include exchanging real-time data with a payor computing system confirming authentication of the transfer instruction and availability of the resources being transferred. The real-time processing may further include sending communications to the payee computing system specified in the transfer instructions. The communications may include a further transfer instruction, which may or may not be in the same structure or format as the original transfer instruction, instructing allocation of the transferred resources to a specified account at the payee computing system. In some other implementations, the real-time transfer rail 180 may be a part of the payee or payor computing system.

In some implementations, the systems described herein may use a transfer rail that is not a real time transfer rail.

A point-of-sale terminal 160 or similar payment processing device, may generate, or to cause a resource management computing system or another system to generate, a transfer instruction that is sent via the computer network 120, and in some cases the real-time transfer rail 180 or another transfer rail, to the computing system 130. The transfer instruction 170 may include an identifier of an account and/or an account holder at the computing system 130 and a transfer quantity. The transfer quantity may be a quantity of resources to be transferred from the account. The resources may include monetary resources or non-monetary resources. The point-of-sale terminal 160 may include a computing system, a computing device. In other implementations, other systems may take the role of the point-of-sale terminal 160. For example, the point-of-sale terminal 160 may be or include or one of the client devices 110 which may include, for example, a physical token reader that connects to the client device 110 either wirelessly or via a physical connection. By way of example, the physical token reader may be a Square™ card reader that operates to convert a mobile device to a point-of-sale terminal.

The system 100 may further include an external resource system. The external resource system may be configured to periodically transfer resources to the user account within the computing system 130. The periodic transfer of resources may occur weekly, bi-weekly, monthly, or on some other schedule in some implementations. That is, the resources in the user account may be replenished or supplemented from the external resource system in regular or somewhat regular intervals. As an example, in the case of a mobile communications account with fixed data usage caps and extra fees for overages, the resources may include data usage and the replenishment may be re-setting of the data usage meter each billing cycle, which equates to allocating the full data usage cap to the account each billing cycle. In another example, the user account may include a bank account and the external resource system may include a payroll system that automatically deposits wages to the bank account in accordance with a payroll schedule. The payroll schedule may be weekly, bi-weekly, monthly, or on some other frequency. The quantity of funds deposited may be fixed in the case of a salaried employee, but subject to various deductions or bonuses or other credits or debits administered by the payroll system. In the case of an hourly employee, the wages may vary from pay period to pay period dependent on the number and type of hours recorded in the payroll system for an employee associated with the user account.

In FIG. 1, the system 100 includes a payroll processor computing system 190. The payroll processor computing system 190 may be a corporate computing system associated with an employer or may include a computing system operated by a third-party payroll processing company. The payroll processor computing system 190 may be configured to transfer funds to the user account in accordance with the payroll data and schedule configured on the payroll processor computing system 190.

In many instances, resources such as data caps, bandwidth, computing resources, payroll funds, etc., are only made available to a user account after the resources have been earned. In many cases, there may be a delay in transferring the resources to the user account after it has been earned. For example, an employee typically works hours for one or two weeks before a payroll is processed to deposit wages associated with the hours worked in the preceding one or two weeks.

In order to facilitate earlier access to earned resources, some services have developed to provide users with early access to such resources prior to the scheduled resource transfer time. For instance, there are earned wages access services 195 that provide employees with access to some or all of their accrued earned wages in advance of a payday. In some cases, this service is provided directly by an employer. In some cases, the service may be provided by a third-party system or application that is approved for use by the employer and/or the payroll processing company. The earned wages access service 195 may charge users a fee, either a flat fee or a percentage, for advancing funds prior to payroll processing time. The earned wages access services 195 are, in any case, provided by a computing system such as a server. Any reference to the earned wages access service 195 is intended to refer to such a computing system.

The earned wages access services 195 may be enabled by an employer and an employee may choose to access the service through an application or web interface in order to submit a request for early access to available wages. The wages may then be advanced through transfer to the associated bank account of the user. When the payroll is eventually processed on its normal schedule, the advanced wages and any fees are deducted from the amount sent to the user's bank account.

This system may provide a user with early access to resources that would otherwise arrive later. This may permit a user to avoid a future default or negative position in a resource account. For instance, early access to the next month's data cap for mobile data usage may address a problem with data overage charges continuing to accrue if a user has reached the data cap for the current billing cycle.

A “default” or negative position of this nature may be referred to herein as an overload condition or a resource threshold event. In many cases, the threshold may be zero, i.e. using up all the resources associated with the account such that the allocated resources in the account reach zero or negative. In some cases, a non-zero threshold may be established. For instance, in some instances, the threshold may be configured to ensure some reserves remain available for unexpected resource demand; for example, the threshold may be set so that at least some resources remain available for emergencies.

In at least some implementations, the threshold may not be the same for all users. A user-specific and/or account-specific threshold may be determined based on account data for a particular user or account. For example, the threshold determined for a particular user may be determined based on whether that particular user tends to have numerous unscheduled and/or discretionary outgoing transfers. By way of example, past outgoing transactions may be categorized as discretionary/non-discretionary and/or as scheduled/unscheduled and such categorizations may affect a particular user's predictability score. Users with a greater number of outgoing transfers in a certain category may have a higher threshold than users with a lesser number of outgoing transfers in that category. For example, users with more unpredictable or discretionary transfers may need to set aside more emergency resources than other users.

A user could anticipate potential resource threshold events, e.g. defaults, and make anticipatory requests for early access to resources before any default occurs; however, this imposes a time and energy cost of constant monitoring of both the user's accounts and any external resource accounts and anticipating future resource usage events. Overly aggressive use of an early resource access system may result in additional costs for the early resource access that end up being more damaging than the costs or penalties associated with the resource threshold event. Moreover, there is a computing energy and bandwidth cost associated with user login and monitoring of account levels and consequent generation of transfer instructions relating to the accounts and external resource accounts.

Accordingly, the present application provides for the transfer instruction handler 145 or another module to determine, when a transfer is initiated, whether an external resource should be accessed to complete the data transfer. The external resource may be, for example, an earned resource. That is, the external resource may be an accumulated resource amount associated with a resource transfer scheduled to occur at a future time. For example, the external resource may be a resource that is transferred with some regularity such as, for example, a top-up transfer. By way of example, the external resource may be earned wages.

Other types of external resources are also contemplated. For example, in some implementations, the external resource may be a borrowed resource which may be provided by a system such as a buy now pay later system.

When the system determines that an external resource should be accessed to complete the data transfer, it may provide a query message to an electronic device (such as one of the client device 110). The query message may prompt for confirmation that the external resource is to be accessed to complete the transfer.

In some implementations, the query message may be or include a user interface screen which displays various transfer options. One of the options may be to access the external resource and, in at least some implementations, another one of the options may be to access an internal resource, such as a resource already stored in the user's account (i.e., a resource in a first logical storage area). In at least some implementations, a further option may be included. The further option may be an option to access another external resource (i.e., a resource external to the first logical storage area or, put differently, external to the database 135 which includes the first logical storage area).

In implementations in which the query message displays multiple options, those options may be displayed in a ranked or ordered manner. The rank or order is based on the determined preference.

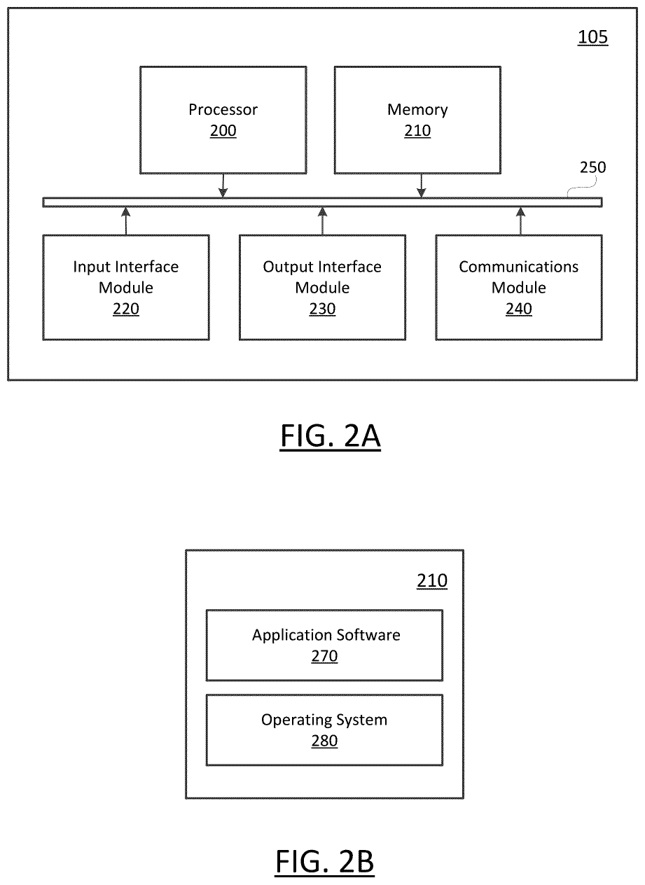

FIG. 2A is a high-level operation diagram of an example computing device 105. In at least some embodiments, the example computing device 105 may be exemplary of one or more of the computing system 130, the transfer processing system 140, the computing device 115, and/or one or more of the client devices 110. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), and/or a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. In some embodiments, the application software 270 may include the transfer instruction handler 145. In some examples, the application software 270 may include a transfer instruction application executed on the computing device 115. The transfer instruction application may, for example, be an embedded or secure application executing in the dedicated hardware of a point-of-sale device or one or more financial institution servers for generating and sending a debit or payment instruction with regard to the user account.

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

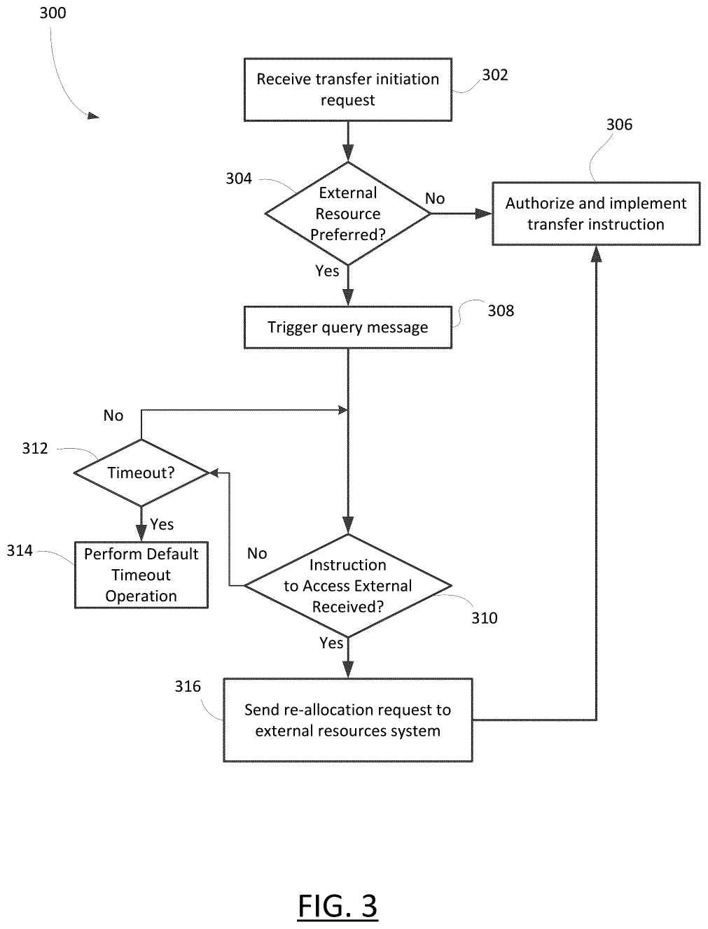

Reference is now made to FIG. 3, which shows, in flowchart form, an example method 300 of handling a transfer event. The method 300 may be implemented by a computing system such as the computing system 130 of FIG. 1. For example, the transfer processing system 140 may be configured by software, such as the transfer instruction handler 145 or another module, to implement the method 300. The method 300 may be performed by a computing system that manages one or both of a sender and a recipient account associated with a transfer message. The method 300 may be performed, for example, by the processor 200 (FIG. 2A) of a computing device 105 executing software comprising instructions such as may be stored in the memory 210 of the computing device 105. More particularly, processor-executable instructions may, when executed, configure a processor 200 of the computing system 130 to perform all or parts of the method 300. In this example, the system receiving the transfer message is referred to as a transfer processing system.

The method 300 may be initiated through receipt by the computing system of an initiation request in an operation 302. For example, the computing system may receive an initiation request for a data transfer. The initiation request may be a request for a data transfer associated with a point-of-sale terminal.

In some implementations, the initiation request may originate from the point-of-sale terminal itself. For example, the initiation request may, in some implementations, be a transfer instruction or transfer request. The transfer instruction or transfer request may be sent after a user, who is a customer at the point-of-sale terminal, has engaged with the point-of-sale terminal using a token. The token may be a physical token such as a payment card such as a credit or debit card.

The token may, in some implementations, be a stored representation of a payment card which may be stored, for example, in a mobile wallet on a customer device. In either case, the token may be read by the point-of-sale terminal. For example, the token may be read using a token reader such as a physical token reader. After the token is read, a transfer instruction or transfer initiation request may be sent to the computing system 130. The computing system may then perform other operations of the method 300. The transfer initiation request may be received at the computing system via a communications subsystem.

The initiation request may be received in other manners. For example, in some implementations, the initiation request may be received via an electronic device associated with an account holder such as, for example, one of the client devices 110, which may send the initiation request to the computing system. The initiation request may be sent by a client device 110 after the client device has scanned or read data from the point-of-sale terminal. For example, the client device 110 may read data the point-of-sale terminal by scanning a machine readable code, such as a Quick Response (QR) displayed on a display of the point-of-sale terminal using a camera. By way of example, the techniques described in U.S. patent application Ser. No. 17/142,605, filed Jan. 6, 2021 for “User Interface Handoff to Enable Feature at a Terminal” may be used to hand off at least a portion of a checkout process to a client device. The contents of this prior application are incorporated herein by reference. After the client device 110 has read the data from the point-of-sale terminal, it may communicate the initiation request to the computing system.

Accordingly, at the operation 302, the computing system may receive an initiation request for a data transfer associated with a point-of-sale terminal. The data transfer may be, for example, a transfer of resources. The initiation request may be associated with a first logical storage area. The first logical storage area may be a logical storage area that is associated with the token that was read at the point-of-sale terminal and/or associated with the client device 110 that sent the initiation requestion.

The initiation request may specify an amount of resources that are to be transferred. The amount may be, for example, a quantity of resources that are to be transferred to complete a transaction at the point-of-sale terminal.

The initiation request may specify other data. For example, the initiation request may include or be associated with an identifier of an account. The account may be associated with the physical token that was read at the point-of-sale terminal and/or the client device 110 that sent the initiation request to the computing system. By way of further example, the initiation request may include or be associated with one or more other identifiers such as, for example, a merchant identifier which may identify a merchant or merchant account. Accordingly, the initiation request may identify or be associated one or both of a first logical storage area and a second logical storage area. The first logical storage area may be or represent a sender or transferor account and the second logical storage area may be or represent a recipient or transferee account.

Referring still to FIG. 3, in an operation 304, the computing system determines, based on account data for the first logical storage area, whether a resource external to the first logical storage area should be accessed to complete the data transfer. The external resource may be, for example, an accumulated resource amount associated with a resource transfer that is scheduled to occur at a future time. The external resource is “external” in that it is not stored in a common database as the first logical storage area and/or that it is managed by a different system than the first logical storage area.

The accumulated resource amount may be or represent an amount of earned wages. The accumulated resource amount may be determined, for example, by sending a resource query message to an earned wage access service 195 to determine whether any earned wages are available and, if so, the amount of earned wages that are available. In at least some implementations, the resource query message may include an entity or account identifier. The identifier may identify a particular entity or account at the external system. For example, the identifier may identify a particular employee having a record at the earned wage access service 195. The identifier may be retrieved from memory on the client device, or from the physical token or from another system that maps data on the physical token to an identifier at the earned wage access service 195. In this way, the external system is able to associate the resource query message with a particular account in order to determine whether accumulated resources are available for immediate release.

In response to the resource query message, the computing system may receive an indicator of an amount of external resources that are available. That is, the indicator may indicate an accumulated resource amount. In this way, the computing system may determine that an accumulated resource amount associated with a resource transfer scheduled to occur at a future time is available for immediate access.

In some implementations, when external resources are available, the computing system may determine at the operation 304 that the external resource is to be accessed to complete the transfer. In other implementations, the mere availability of external resources is not sufficient to determine that such resources are to be used. Rather, it may be that the computing system may require one or more other conditions to be satisfied before it will be determined that such resources are to be used. In some implementations, determining, based on account data for the first logical storage area, that a resource external to the first logical storage area should be accessed to complete the data transfer further includes determining that the accumulated resource amount is of an amount sufficient to complete the transfer. That is, in some implementations, the computing system only determines that the external resource should be used if the accumulated resource amount is sufficient to complete the transfer. In some implementations, this may include determining that the amount of accumulated resource is greater than or equal to the amount of resources requested to be transferred. In some implementations, the accumulated resource amount will be determined to be sufficient to complete the transfer if the sum of resources available in the internal account (i.e., in the first local storage area) and resources available in the external account (i.e., the accumulated resources) exceeds the amount requested to be transferred in the transfer initiation request.

In some instances, determining, based on account data for the first logical storage area, that a resource external to the first logical storage area should be accessed to complete the data transfer further includes determining that at least a threshold amount of resources will remain available for transfer at the scheduled time if the transfer were to be completed with resources in the accumulated resource amount. That is, the system may only determine that external resources should be accessed to complete the data transfer if doing so will leave at least a threshold of such external resources remaining in the external account. Or, put differently, it will ensure that at least a threshold of accumulated resources remain available in the external account either at a current time or at the scheduled time for the transfer. The threshold is defined to ensure that the accumulated resources are not drawn down to a point where the user will fall short of needed resources on the regularly scheduled transfer date. The threshold may be defined in absolute terms (such as a fixed amount) or in relative terms (such as a percentage).

The threshold may be specific to the user and/or account. That is, at least some accounts at the external system may have different associated thresholds than at least some other such accounts. The computer system may determine a threshold for a particular user/account based on account data for such an account. For example, the threshold may be determined based on an amount of known transfers that are expected to fall due between the next scheduled transfer date and the scheduled transfer date after that date. Such known transfers may be or include outgoing transfers such as rent payments, mortgage payments, utility bills, etc. Users with larger known transfers falling due between the next scheduled transfer date and the scheduled transfer date after that date may be expected to have a threshold that will leave a greater amount of resources to be transferred on the scheduled transfer date than users with smaller known transfers.

The external resources may take other forms apart from accumulated resources. For example, in some implementations, the external resources that are assessed at the operation 304 may be borrowed resources. In at least some implementations, determining, based on account data for the first logical storage area, that a resource external to the first logical storage area should be accessed to complete the data transfer may include determining that a borrowed resource is available to complete the transfer. That is, the computing system may determine that the external resource should be accessed when borrowed resources are determined to be available. The borrowed resources may be associated with a post paid service such as a buy now pay later (BNPL) service. If no borrowed resources are available, then the computing system may determine the external resource should not be accessed.

In some implementations, determining, based on account data for the first logical storage area, that a resource external to the first logical storage area should be accessed to complete the data transfer may include determining that an overload condition will occur at a future time without use of the resource external to the first logical storage area. The overload condition may be determined to occur based on predicted future transfers identified based on past transfers. That is, in at least some implementations, the computing system will determine if an overload condition will occur in the future if the external resource is not used and, if it will occur in the future and if sufficient external resources are available, it may determine that the external resource should be used. Determining whether an overload condition will occur in the future may be determined based on expected inflows and outflows to the first logical storage area. The expected inflows and outflows may include scheduled transfers and may also include predicted transfers. Predicted transfers are transfers that may not be configured yet but that are expected to occur based on past transfer data. For example, the predicted transfers may include recurring or periodic transfers. In this way, the system may predict transfers that are likely to occur in the future and may attempt to avoid overload conditions in the future taking into account these predicted transfers. The overload condition may be determined based on owned resources or borrowed resources. For example, in some instances the first logical storage area may indicate an amount of owned resources such as a bank balance and in other instances it may indicate an amount of borrowed resources such as an available credit limit.

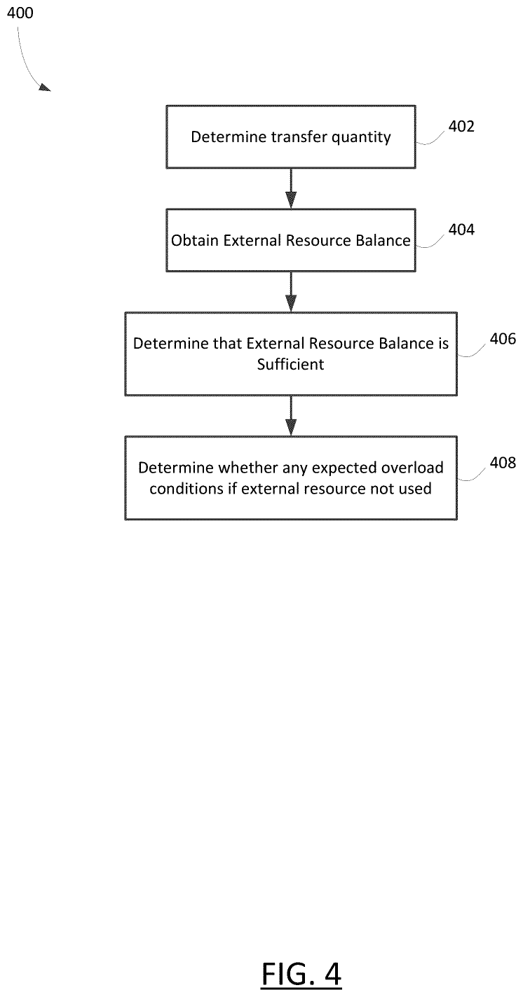

Operations that may be performed at the operation 304 in order to determine whether an external resource should be used are described in further detail below with reference to FIG. 4.

If the computing system determines that the external resource should not be used based on the account data (which may include the past transaction history, present balance, etc.) then the system may, at an operation 306, authorize and implement a transfer instruction in the normal course. This may include updating the data records associated with the user account (i.e., updating the first logical storage area) to reflect removal of the transfer quantity of resources from the user account and generation and transmission of any communications prescribed for confirming and giving effect to the transfer of those resources to the identified recipient account. The computing system may also cause the point-of-sale terminal to be updated by, for example, updating a display on the point-of-sale terminal to indicate completion of the transfer.

If, however, it is determined at the operation 304 that a resource external to the first logical storage area should be accessed to complete the data transfer, then an operation 308 may be performed. At the operation 308, the computing system may trigger a query message to an electronic device accessible to an entity associated with the first logical storage area. The query message may prompt for an instruction to access the resource external to the first logical storage area to complete the transfer. The query message may also be referred to as one or more of a notification, a prompt, an electronic message, and an interface.

The electronic device upon which the query message is output may be one or both of the point-of-sale terminal and a device associated with the first logical storage area. For example, the query message may be output on the client device 110 from which the transfer initiation request was received or it may be output on a client device 110 that has been registered in association with the first logical storage area.

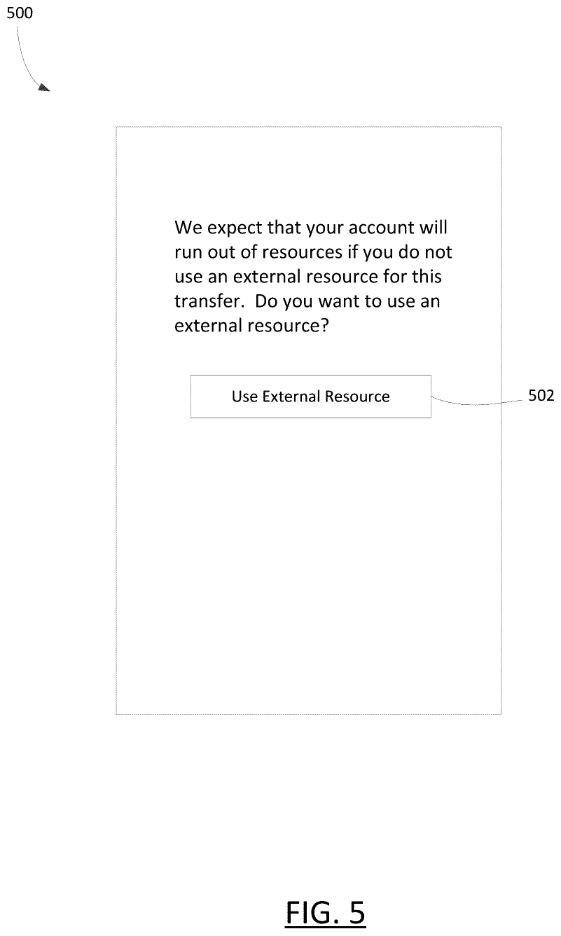

Reference will briefly be made to FIG. 5 which illustrates an example query message 500. The example query message indicates that a resource external to the first logical storage area should be used to complete the transfer. For example, the query message 500 may indicate that accumulated resources associated with a resource transfer scheduled to occur at a future time should be used to complete the transfer.

As illustrated, the example query message 500 may include one or more interface elements such as a selectable interface element 502. The selectable interface element may be or include an option to use the external resource to complete the transfer. Activation of such an option will cause an instruction to access external resources to be issued to the computing system. Activation of such an option may cause external resources to be used to complete the transfer.

The query message 500 may include an option to decline the suggestion of using the external resource. For example, the query message 500 may include an option to use resources in the first logical storage area to complete the transfer.

After sending the query message at the operation 308, the computing system may monitor for a response. For example, a response may be sent when a selectable option that is caused to be displayed by the query message is selected using an input interface.

Accordingly, the computing system may determine at the operation 310 whether an instruction to access an external resource has been received. If no instruction is received within a timeout period (which may be evaluated at an operation 312) then a default timeout operation may be performed at an operation 314. The default timeout operation may be, for example, to perform the operation 306. Alternatively, the default timeout operation may be to decline the transfer in which case the computing system may notify the point-of-sale terminal that the transfer has been declined.

If, however, the computing system receives, from the electronic device, an instruction to access the resource external to the first logical storage area to complete the transfer at the operation 310, then the computing system may affect the transfer using the resource external to the first logical storage area.

Affecting the transfer using the resource external to the first logical storage area may include various operations. For example, affecting the transfer using the resource external to the first logical storage area may include sending (at an operation 316) a transfer request to an external resource system to re-allocate a first quantity of resources from an external logical storage area to another logical storage area. The external resource system may be an earned wages access service 195. The another logical storage area may be the first logical storage area. In such implementations, the operation 306 may then be performed to cause a further transfer from the first logical storage area to a storage area associated with a merchant that is associated with the point-of-sale terminal.

Alternatively, in some implementations, the another logical storage area may be a storage area associated with a merchant that is associated with the point-of-sale terminal. That is, the transfer may be made directly from the external logical storage area (i.e., the external account) to the merchant account without passing through the user account.

When the transfer is performed at the operation 306, the computing system or another system may cause the point-of-sale terminal to be updated to indicate, to the operator, such as a cashier, that the transaction has been completed.

Reference will now be made to FIG. 4, which illustrates example operations that may be performed by the computing system as part of the operation 304 of the method 300. The operations of FIG. 4 may be referred to as a method 400. The method 400 may be implemented by a computing system such as the computing system 130 of FIG. 1. For example, the transfer processing system 140 may be configured by software, such as the transfer instruction handler 145 or another module, to implement the method 400. The method 400 may be performed by a computing system that manages one or both of a sender and a recipient account associated with a transfer message. The method 400 may be performed, for example, by the processor 200 (FIG. 2A) of a computing device 105 executing software comprising instructions such as may be stored in the memory 210 of the computing device 105. More particularly, processor-executable instructions may, when executed, configure a processor 200 of the computing system 130 to perform all or parts of the method 400. In this example, the system receiving the transfer message is referred to as a transfer processing system.

At an operation 402, the computing system may determine a transfer quantity. The transfer quantity may also be referred to as a transfer amount. The transfer quantity may be determined from data received in the transfer initiation request or received in association with the transfer initiation request (see the operation 302).

At an operation 404, the computing system may obtain an external resource balance. The external resource balance may be obtained using an interface, such as an application programming interface (API) associated with an external system such as an earned wage access service 195.

Then, at an operation 406, the computing system may determine whether the external resource balance is sufficient. The external resource balance may be an accumulated resource amount associated with a resource transfer scheduled to occur at a future time. At the operation 406, the computing system may determine that the resource balance is sufficient by determining that it is greater than or equal to the transfer quantity. If the computing system, instead, determines that it is insufficient, subsequent operations of the method 400 may not be performed and the system may determine that the external resource should not be used.

At an operation 408, the computing system may determine whether any expected overload conditions will exist if the external resource is not used. If, for example, the computing system determines that no external resources are needed to avoid any future overload conditions, then it may determine that external resources should not be used. If, however, the computing system determines that external resources are, in fact, needed to avoid a future overload condition, then it may determine that external resources should be used.

Variations of the systems and methods described above are contemplated. For example, in some implementations, the computing device may not perform the operation 306 in response to determining that an external resource should not be used. Rather, the computing system may send a query message to an electronic device associated with the user in both the case that it determines that external resources should be used and the case that it determines that external resources should not be used. The query message may include both a selectable option to use the resources already in the first logical storage area and a selectable option to use resources external to the first logical storage area. These options may be presented so as to indicate which of the options is preferred, recommended or suggested. The preference may be conveyed, for example, through the ordering of the options. A topmost option may be selected to identify the preferred one of the options, as determined by the computing system and a lower option may be selected to identify an options which is not as preferred, as determined by the computing system. Other techniques may be used to convey suggestions or preferences. For example, a preferred option may be displayed together with an indication which indicates that it is preferred.

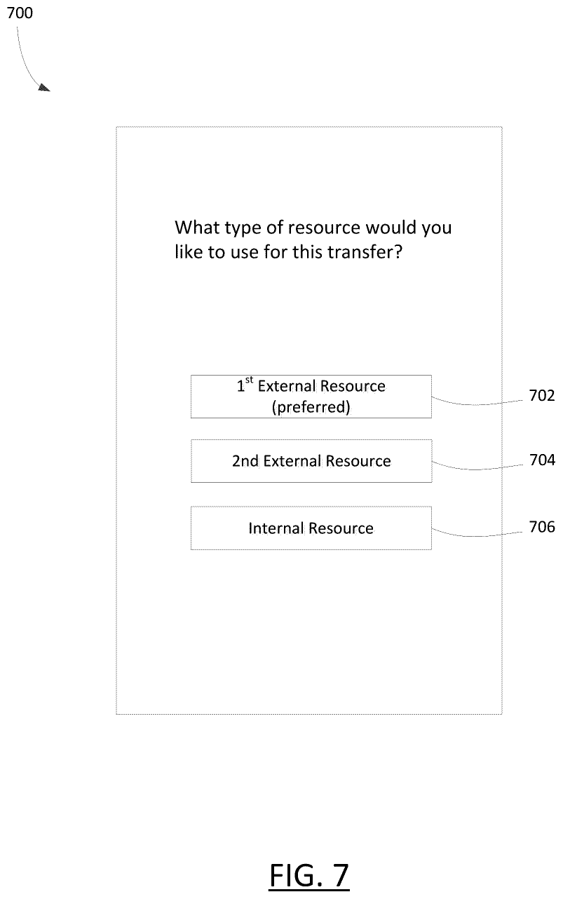

An example query message 700 that highlights suggested preferences is illustrated in FIG. 7. In the example of FIG. 7, preferences are conveyed by presenting selectable options in a ranked list in which a topmost option 702 is a suggested option and a bottom-most option 706 is a least suggested option. In some instances, the query message may include a further option 704 that is not as preferred as the topmost option 702 but more preferred than the bottom-most option 706.

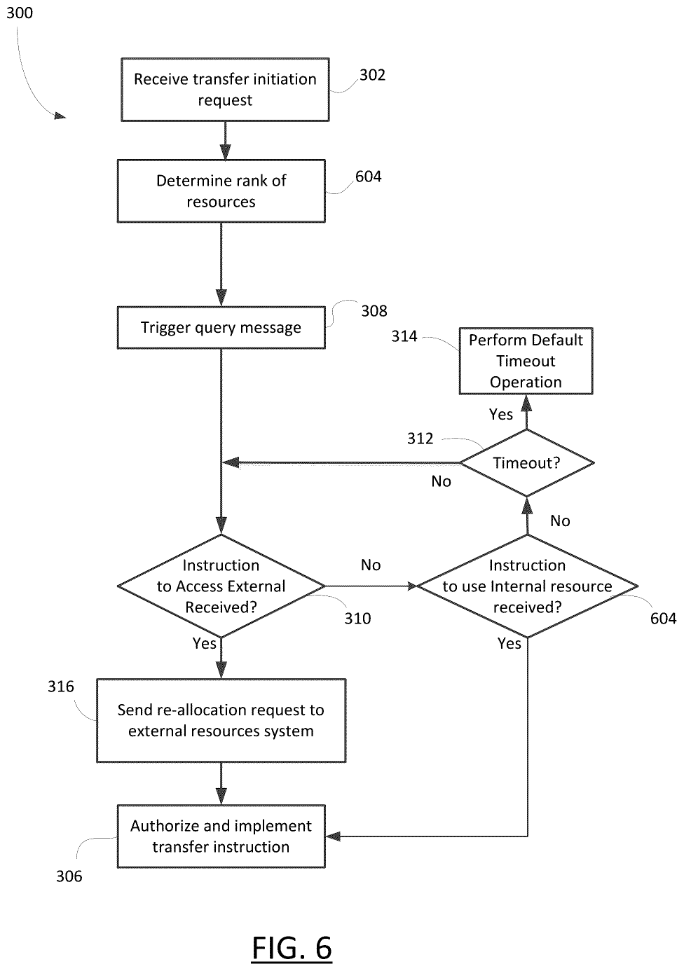

An example of a modified method 600 of handling a transfer event is illustrated in FIG. 6. FIG. 6 shows, in flowchart form, an example method 600 of handling the transfer event. The method 600 may be implemented by a computing system such as the computing system 130 of FIG. 1. For example, the transfer processing system 140 may be configured by software, such as the transfer instruction handler 145 or another module, to implement the method 600. The method 600 may be performed by a computing system that manages one or both of a sender and a recipient account associated with a transfer message. The method 600 may be performed, for example, by the processor 200 (FIG. 2A) of a computing device 105 executing software comprising instructions such as may be stored in the memory 210 of the computing device 105. More particularly, processor-executable instructions may, when executed, configure a processor 200 of the computing system 130 to perform all or parts of the method 600. In this example, the system receiving the transfer message is referred to as a transfer processing system.

The method 600 may include many operations in common with the method 300 of FIG. 3 and, for the sake of brevity, the discussion of such operations will not be repeated.

As with the method 300 of FIG. 3, the method 600 of FIG. 6 may include an operation 302 of receiving a transfer initiation request. The method may also include an operation 604 of determining a ranking of resources. The operation 604 may be performed similar to the operation 304 but the resources may be ranked. If, using the techniques of operation 304, the computing system determines that the external resource should be accessed, then it will rank the external resource more highly than the resource already in the first logical storage area. If, instead, it determines that the external resource should not be accessed, then it will rank the first logical storage area higher than the external resource.

Next, at the operation 308, a query message may be triggered on an electronic device such as the point-of-sale terminal or the client device. The query message may be of the type described with reference to FIG. 6. For example, an order of the transfer options may reflect suggested options such that the option to use the external resource to complete the transfer is displayed more prominently in response to determining that the resource external to the first logical storage area should be accessed to complete the data transfer.

The computing system then waits for an instruction. If an instruction to use an external resource is received at the operation 310 (similar to the operation 310 of the method 300), then the computing system may access the external resources by performing the operations 316 and 306 described above with reference to the method 300. If, however, an instruction to use an internal resource (i.e., a resource in the first logical storage area) is received (as determined at operation 604), then the operation 316 is not performed. Instead, the method proceeds to operation 306 where the transfer is performed using the resources in the first logical storage area.

As with the method 300, the method 600 may include a timeout detection operation 312 and a default timeout operation (which may be performed at operation 314).

The operations 302, 306, 308, 310, 312, 314, 316 of the method 600 may be performed in the same or a similar manner as the operations with the same reference numbers of the method 300 of FIG. 3.

Other variations of the above systems and methods are also contemplated. For example, in some implementations, a physical token may be provided to a user and that physical token may be associated with an external account (such as an account at the earned wages access service 195). When a user is desirous of accessing accumulated resources associated with a future scheduled transfer to complete an immediate transfer, they may use such a physical token at a point of sale terminal.

In a further variation, it may be that a new physical token is not issued for earned wage access. Instead, an existing physical token such as an existing debit or credit card may be linked to an earned wage access account. Then, the earned wage access may act as a backup funding mechanism when funds are not otherwise available. For example, if the card is a debit card and the customer's account balance does not have sufficient funds to complete the transaction, then the earned wages may be accessed using the on-the-fly techniques described above.

In the case of a credit card, the earned wages may be accessed when there is insufficient credit available. The system may not allow full access to all earned wages early since the customer may then be unable to pay off the full credit balance. For example, a threshold may be defined to control the amount of earned wages that are accessible. It may be, for example, that the threshold only permits access to 60% of earned wages. The threshold may be controlled intelligently. For example, it may depend on whether the customer has a mortgage, the customer's income, etc.

In one variation of the above, it may be earned wage access may be completed without an earned wage access platform. For example, the bank may effectively lend the customer funds that are secured against the customer's next paycheck. For example, the bank may determine an amount of earned wages that are available for the customer based on the last pay date, the typical pay amount, and the pay frequency. Then, if the customer has wages available, the bank may allow the customer to access such wages using loaned funds until the next pay date. When the pay is received, the loaned amount may be automatically returned. A fee may be paid by the customer for early earned wage access.

It will be appreciated and understood that various of the example operations described with regard to the exemplary methods detailed above may be carried out substantially contemporaneously or in a different order from that presented without materially impacting the functioning of the method, and those variations are included herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system for handling a transfer event, comprising:
a processor;
a communications module coupled to the processor; and
a memory coupled to the processor, the memory storing processor-executable instructions that, when executed by the processor, cause the processor to:
receive an initiation request for a data transfer associated with a point-of-sale terminal, the initiation request associated with a first logical storage area;
determine, based on account data for the first logical storage area, that a resource external to the first logical storage area should be accessed to complete the data transfer;
in response to determining that the resource external to the first logical storage area should be accessed to complete the data transfer, trigger a query message to an electronic device accessible to an entity associated with the first logical storage area, the query message prompting for an instruction to access the resource external to the first logical storage area to complete the transfer;
receive, from the electronic device, an instruction to access the resource external to the first logical storage area to complete the transfer; and
in response to receiving the instruction to access the resource external to the first logical storage area, effect the transfer using the resource external to the first logical storage area.

2. The computing system of claim 1, wherein the electronic device accessible to the entity includes one or both of the point-of-sale terminal and a device associated with the first logical storage area.

3. The computing system of claim 1, wherein effecting the transfer using the resource external to the first logical storage area includes sending a transfer request to an external resource system to re-allocate a first quantity of resources from an external logical storage area to another logical storage area.

4. The computing system of claim 3, wherein the another logical storage area is the first logical storage area.

5. The computing system of claim 3, wherein the another logical storage area is a storage area associated with a merchant that is associated with the point-of-sale terminal.

6. The computing system of claim 3, wherein determining, based on account data for the first logical storage area, that a resource external to the first logical storage area should be accessed to complete the data transfer includes determining that an accumulated resource amount associated with a resource transfer scheduled to occur at a future time is available for immediate access.

7. The computing system of claim 6, wherein determining, based on account data for the first logical storage area, that a resource external to the first logical storage area should be accessed to complete the data transfer further includes determining that the accumulated resource amount is of an amount sufficient to complete the transfer.

8. The computing system of claim 6, wherein determining, based on account data for the first logical storage area, that a resource external to the first logical storage area should be accessed to complete the data transfer further includes determining that at least a threshold amount of resources will remain available for transfer at the scheduled future time if the transfer were to be completed with resources in the accumulated resource amount.

9. The computing system of claim 8, wherein the instructions configure the processor to determine the threshold amount based on the account data.

10. The computing system of claim 1, wherein the query message indicates that the resource external to the first logical storage area should be used to complete the transfer.

11. The computing system of claim 1, wherein the query message indicates a plurality of transfer options including an option to use the resource external to the first logical storage area to complete the transfer and an option to use resources in the first logical storage area to complete the transfer.

12. The computing system of claim 11, wherein an order of the transfer options reflects suggested options such that the option to use the external resource to complete the transfer is displayed more prominently in response to determining that the resource external to the first logical storage area should be accessed to complete the data transfer.

13. The computing system of claim 1, wherein determining, based on account data for the first logical storage area, that a resource external to the first logical storage area should be accessed to complete the data transfer includes determining that a borrowed resource is available to complete the transfer.

14. The computing system of claim 1, wherein determining, based on account data for the first logical storage area, that a resource external to the first logical storage area should be accessed to complete the data transfer includes determining that an overload condition will occur at a future time without use of the resource external to the first logical storage area and wherein the overload condition to determined to occur based on predicted future transfers identified based on past transfers.

15. A method comprising:
receiving an initiation request for a data transfer associated with a point-of-sale terminal, the initiation request associated with a first logical storage area;
determining, based on account data for the first logical storage area, that a resource external to the first logical storage area should be accessed to complete the data transfer;
in response to determining that the resource external to the first logical storage area should be accessed to complete the data transfer, triggering a query message to an electronic device accessible to an entity associated with the first logical storage area, the query message prompting for an instruction to access the resource external to the first logical storage area to complete the transfer;
receiving, from the electronic device, an instruction to access the resource external to the first logical storage area to complete the transfer; and
in response to receiving the instruction to access the resource external to the first logical storage area to complete the transfer, effecting the transfer using the resource external to the first logical storage area.

16. The method of claim 15, wherein the electronic device accessible to the entity includes one or both of the point-of-sale terminal and a device associated with the first logical storage area.

17. The method of claim 15, wherein effecting the transfer using the resource external to the first logical storage area includes sending a transfer request to an external resource system to re-allocate a first quantity of resources from an external logical storage area to another logical storage area.

18. The method of claim 17, wherein the another logical storage area is the first logical storage area.

19. The method of claim 18, wherein the another logical storage area is a storage area associated with a merchant that is associated with the point-of-sale terminal.

20. The method of claim 18, wherein determining, based on account data for the first logical storage area, that a resource external to the first logical storage area should be accessed to complete the data transfer includes determining that an accumulated resource amount associated with a resource transfer scheduled to occur at a future time is available for immediate access.

21. The method of claim 20, wherein determining, based on account data for the first logical storage area, that a resource external to the first logical storage area should be accessed to complete the data transfer further includes determining that the accumulated resource amount is of an amount sufficient to complete the transfer.

22. The method of claim 20, wherein determining, based on account data for the first logical storage area, that a resource external to the first logical storage area should be accessed to complete the data transfer further includes determining that at least a threshold amount of resources will remain available for transfer at the scheduled future time if the transfer were to be completed with resources in the accumulated resource amount.

23. The method of claim 22, further comprising determining the threshold amount based on the account data.

24. The method of claim 15, wherein the query message indicates that the resource external to the first logical storage area should be used to complete the transfer.

25. The method of claim 15, wherein the query message indicates a plurality of transfer options including an option to use the external resource to complete the transfer and an option to use resources in the first logical storage area to complete the transfer.

26. The method of claim 25, wherein an order of the transfer options reflects suggested options such that the option to use the external resource to complete the transfer is displayed more prominently in response to determining that the resource external to the first logical storage area should be accessed to complete the data transfer.

27. The method of claim 15, wherein determining, based on account data for the first logical storage area, that a resource external to the first logical storage area should be accessed to complete the data transfer includes determining that a borrowed resource is available to complete the transfer.

28. The method of claim 15, wherein determining, based on account data for the first logical storage area, that a resource external to the first logical storage area should be accessed to complete the data transfer includes determining that an overload condition will occur at a future time without use of the resource external to the first logical storage area and wherein the overload condition to determined to occur based on predicted future transfers identified based on past transfers.
